(19) United States
(12) Patent Application Publication
(10) Pub. No.: US 2008/0266281 A1
(43) Pub. Date: Oct. 30, 2008

(54) Gamma voltage output circuit and liquid crystal display device having same

(75) Inventor: Zhong-Ru Li, Shenzhen (CN)

Correspondence Address: WEI TE CHUNG;FOXCONN INTERNATIONAL, INC., 1650 MEMOREX DRIVE, SANTA CLARA, CA, 95050, US

(73) Assignee: INNOCOM TECHNOLOGY (SHENZHEN) CO., LTD.; INNOLUX DISPLAY CORP.

(21) Appl. No.: 12/150,270

(22) Filed: Apr. 25, 2008

(30) Foreign Application Priority Data
Apr. 25, 2007 (CN) 200710074212.4

(51) Int. Cl. G09G 5/00; G09G 3/36

(52) U.S. Cl. 345/211; 345/87

(57) ABSTRACT

An exemplary gamma voltage output circuit (2) for a liquid crystal display device, which includes a resistor string, and a constant current source (21) providing a current to the resistor string. The resistor string has a plurality of resistor units R21˜R2(n+3), each of nodes between two corresponding adjacent resistors being defined as an output terminal for outputting a gamma voltage.

### FIELD OF THE INVENTION

The present invention relates to voltage output circuits, and more particularly to a gamma voltage output circuit for driving a liquid crystal display device (LCD) and a liquid crystal display device having the same.

### BACKGROUND

LCDs are commonly used as display devices for compact electronic apparatuses, because they not only provide good quality images with little power but also are very thin. In general, an LCD includes a liquid crystal panel and a backlight module for illuminating the liquid crystal panel.

The LCD panel needs to be driven by gamma voltages in order to display images. The gamma voltages are provided from an external apparatus. Each gray scale of the images displayed by the LCD panel corresponds to a gamma voltage signal.

Referring to FIG. 2, a typical gamma voltage output circuit is shown. The gamma voltage output circuit 1 includes an analog electrical source 10 for providing an analog voltage power AVDD1, a first filter capacitor C₁₁, and a voltage divider circuit 15. The voltage divider circuit 15 includes a resistor string connected between the analog electrical source 10 and ground, which includes number N+1 resistors R₁₁˜R₁₍ₙ₊₁₎ connected in series. Each of nodes respectively between two corresponding adjacent resistors is grounded via one of the plurality of capacitors C₁₂˜C₍ₙ₊₁₎, which is electrically connected to an output port (not labeled) of the voltage divider circuit 15 for outputting a gamma voltage. Thus, the voltage divider circuit 15 can output number N gamma voltages V₁₁˜V₁ₙ.

In the gamma voltage output circuit 1, the voltage output from the analog electrical source 10 is distributed to the resistors R₁₁˜R₁₍ₙ₊₁₎ of the voltage divider circuit 15, and the capacitors C₁₂˜C₁₍ₙ₊₁₎ have a function of wave filtering. Thus, each gamma voltage can be calculated according to the following equations:

$$\begin{matrix}I 1 = AVDD 1 / R 0 \\ R 0 = {R}_{11} + {R}_{12} + {R}_{13} + {R}_{14} + … + {R}_{1 ( n + 1 )} \\ {V}_{11} = I 1 ( {R}_{12} + {R}_{13} + {R}_{14} + … + {R}_{1 ( n + 1 )} ) \\ {V}_{12} = I 1 ( {R}_{12} + {R}_{13} + {R}_{14} + … + {R}_{1 ( n + 1 )} ) \\ {V}_{13} = I 1 ( {R}_{13} + {R}_{14} + … + {R}_{1 ( n + 1 )} ) \\ ⋮ \\ {V}_{1 n} = I 1 {R}_{1 ( n + 1 )}\end{matrix}$$

When any one gamma voltage outputted by the voltage divider circuit 15 needs to be modulated according to needs, the resistances of the corresponding resistors need to be adjusted. For example, when the gamma voltage V₁₂ needs to be modulated, then the resistance of the resistors 13 needs to be adjusted. However, according to the equations shown above, when the resistance of any one of the resistors is varied, the current I1 is varied and the value of other output gamma voltages also varies. That is, the gamma voltages output from the gamma voltage output circuit 1 affect one another, and cannot be adjusted individually.

Accordingly, what is needed is a gamma voltage output circuit that can overcome the above-described deficiencies.

### SUMMARY

An exemplary gamma voltage output circuit for a LIQUID CRYSTAL DISPLAY DEVICE includes a resistor string, and a constant current source providing a current to the resistor string. The resistor string has a plurality of resistor units, each of nodes between two corresponding adjacent resistors being defined as an output terminal for outputting a gamma voltage.

An exemplary liquid crystal display device includes a liquid crystal panel; and a gamma voltage output circuit outputting gamma voltage to the liquid crystal panel for displaying images. The gamma voltage output circuit includes a resistor string, and a constant current source providing a current to the resistor string. The resistor string has a plurality of resistor units, each of nodes between two corresponding adjacent resistors being defined as an output terminal for outputting a gamma voltage.

Other novel features and advantages will become apparent from the following detailed description of preferred and exemplary embodiments when taken in conjunction with the accompanying drawings.

### BRIEF DESCRIPTION OF THE DRAWINGS

FIG. 1 is an abbreviated diagram of a gamma voltage output circuit according to an exemplary embodiment of the present invention.

FIG. 2 is an abbreviated diagram of a conventional gamma voltage output circuit, the gamma voltage output circuit including a resistor string.

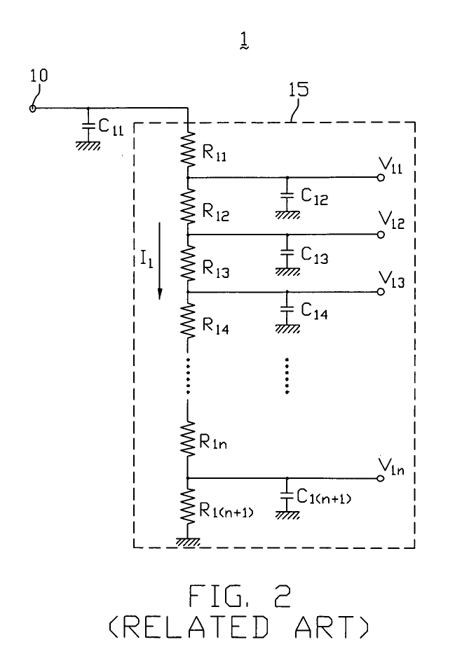

### DETAILED DESCRIPTION OF PREFERRED EMBODIMENTS

Reference will now be made to the drawings to describe preferred and exemplary embodiments in detail.

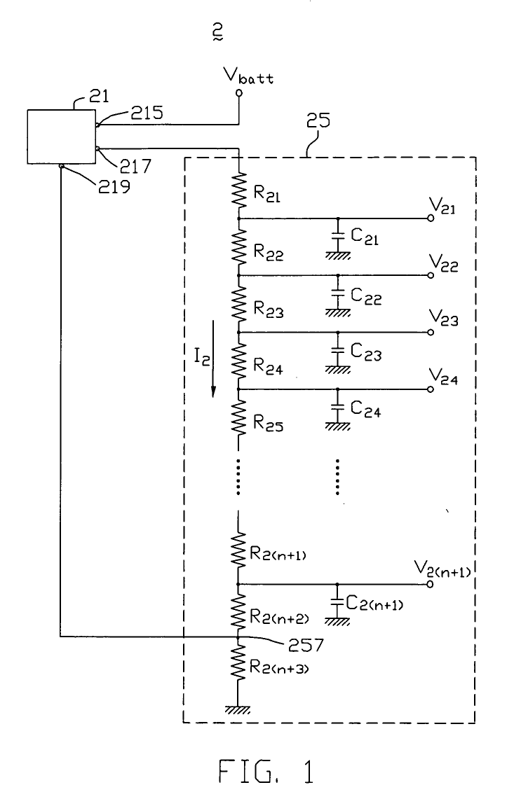

Referring to FIG. 1, this is a circuit diagram of a gamma voltage output circuit according to an exemplary embodiment of the present invention. The gamma voltage output circuit 2 is used to output gamma voltages to drive an LCD panel (not shown) to display images. The gamma voltage output circuit 2 includes a constant current source 21, a voltage source V_{batt}, and a voltage divider circuit 25. The constant current source 21 includes a first input port 215, a first output port 217, and a feedback port 219. The voltage source V_{batt} is electrically connected to the first input port 215 of the constant current source 21 for supplying voltage to the constant current source 21. The voltage divider circuit 25 is electrically connected to the first output port 217 of the constant current source 21, which the constant current source 21 provides a constant current to the voltage divider 25. In addition, the feedback port 219 of the constant current source 21 is used to receive a feedback voltage of the voltage divider circuit 25 for adjusting the constant current thereof.

The voltage divider circuit 25 includes a resistor string connected between the first output port 217 and ground, which includes number N+3 resistors R₂₁˜R₂₍ₙ₊₃₎ connected in series. Each of nodes respectively between two corresponding adjacent resistors R₂₁˜R₂₍ₙ₊₂₎ is grounded via one of the plurality of capacitors C₂₁˜C₂₍ₙ₊₁₎, which is respectively electrically connected to one of the plurality of output ports V₂₁˜V₂₍ₙ₊₁₎ of the voltage divider circuit 25 for outputting gamma voltages. Thus, the voltage divider circuit 25 can output number N+1 gamma voltages V₂₁˜V₂₍ₙ₊₁₎. In addition, a node between the two adjacent resistor R_{2(n+2), R}₂₍ₙ₊₃₎ is defined as a voltage feedback output port 257, which is connected to the feedback port 219 of the constant current source 21 for returning the operation voltage between the two adjacent resistors R₂₍ₙ₊₂₎, R₂₍ₙ₊₃₎ to the constant current source 21. The constant current source 21 can adjust an output current I2 according to the feedback voltage to keep the output current I2 invariable.

In the gamma voltage output circuit 1, the current output from the constant current source 21 is distributed to the resistors R₂₁˜R₂₍ₙ₊₃₎ of the voltage divider circuit 25, and the capacitors C₂₂˜C₂₍ₙ₊₁₎ have a function of wave filtering. Thus, each gamma voltage can be calculated according to the following equations:

$$\begin{matrix}{V}^{′} = {I}_{2} {R}^{′} \\ {R}^{′} = {R}_{21} + {R}_{22} + {R}_{23} + {R}_{24} + … + {R}_{2 ( n + 3 )} \\ {V}_{21} = {I}_{2} ( {R}_{22} + {R}_{23} + {R}_{24} + … + {R}_{2 ( n + 3 )} ) \\ {V}_{22} = {I}_{2} ( {R}_{23} + {R}_{24} + … + {R}_{2 ( n + 3 )} ) \\ {V}_{23} = {I}_{2} ( {R}_{24} + … + {R}_{2 ( n + 3 )} ) \\ {V}_{24} = {I}_{2} ( {R}_{25} + … + {R}_{2 ( n + 3 )} ) \\ ⋮ \\ {V}_{2 ( n + 1 )} = {I}_{2} ( {R}_{2 ( n + 2 )} + {R}_{2 ( n + 3 )} )\end{matrix}$$

wherein R′ represents the resistance sum of the voltage divider circuit 25.

When any one gamma voltage outputted by the voltage divider circuit 25 needs to be modulated according to needs, the resistances of the corresponding two adjacent resistors need to be adjusted. For example, when the gamma voltage V₂₃ needs to be modulated, then the resistances of the two adjacent resistors R₂₃, R₂₄ need to be adjusted for keeping the resistance sum of the two adjacent resistors R₂₃, R₂₄ is invariable. However, according to the equations shown above, when the resistance of one of the resistor 23 and the resistor 24 is varied, the current I2 still keeps constant. Thus, the value of other output gamma voltages V₂₄˜V₂₍ₙ₊₁₎ keeps invariable. That is, the gamma voltages V₂₄˜V₂₍ₙ₊₁₎ output from the gamma voltage output circuit 2 are not affected.

Unlike with the above-described conventional gamma voltage output circuit 1, the gamma voltage output circuit 2 utilizes a constant current source 21 to realize a simple gamma voltage output adjustment. That is, each gamma voltage only relates to two corresponding adjacent resistors connected to the output port thereof. In addition, comparing to the above-described conventional gamma voltage output circuit 1, each gamma voltage adjustment influences fewer gamma voltage output. Moreover, the voltage feedback to the constant current source 21 can assure the precise gamma voltage output and operation of the gamma voltage output circuit 2.

In an alternative embodiment, the resistor string of the voltage divider circuit 25 includes a plurality of resistor units. Each of the includes at least two resistors connected in parallel, or includes a plurality of resistors connected in series-parallel.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A gamma voltage output circuit for a LIQUID CRYSTAL DISPLAY DEVICE, the gamma voltage output circuit comprising:
a resistor string comprising a plurality of resistor units, each of nodes between two corresponding adjacent resistors being defined as a output terminal for outputting a gamma voltage;
a constant current source providing a current to the resistor string.

2. The gamma voltage output circuit as claimed in claim 1, wherein one node between two adjacent resistors close to ground is defined as a voltage feedback terminal for outputting a feedback voltage.

3. The gamma voltage output circuit as claimed in claim 2, wherein the voltage feedback terminal is connected to the constant current source for outputting the feedback voltage to the constant current source.

4. The gamma voltage output circuit as claimed in claim 2, wherein each nodes respectively between the two corresponding adjacent resistors, except that the two adjacent resistors close to ground is grounded via a filter capacitor for wave filtering between the two corresponding adjacent resistors to attain the gamma voltage.

5. The gamma voltage output circuit as claimed in claim 1, wherein each of the resistor units is one resistor.

6. The gamma voltage output circuit as claimed in claim 1, wherein each of the resistor units includes at least two resistors connected in parallel.

7. The gamma voltage output circuit as claimed in claim 1, wherein each of the resistor units includes a plurality of resistors connected in series-parallel.

8. The gamma voltage output circuit as claimed in claim 1, further comprising a power source for providing voltage to the constant current source.

9. A liquid crystal display device, comprising:
a liquid crystal panel;
a gamma voltage output circuit outputting gamma voltage to the liquid crystal panel for displaying images, the gamma voltage output circuit comprising:
a resistor string comprising a plurality of resistor units, each of nodes between two corresponding adjacent resistors being defined as a output terminal for outputting a gamma voltage;
a constant current source providing a current to the resistor string.

10. The liquid crystal display device as claimed in claim 9, wherein one node between two adjacent resistors close to ground is defined as a voltage feedback terminal for outputting a feedback voltage.

11. The liquid crystal display device as claimed in claim 10, wherein the voltage feedback terminal is connected to the constant current source for outputting the feedback voltage to the constant current source.

12. The liquid crystal display device as claimed in claim 10, wherein each nodes respectively between the two corresponding adjacent resistors, except that the two adjacent resistors close to ground is grounded via a filter capacitor for wave filtering between the two corresponding adjacent resistors to attain the gamma voltage.

13. The liquid crystal display device as claimed in claim 9, wherein each of the resistor units is one resistor.

14. The liquid crystal display device as claimed in claim 9, wherein each of the resistor units includes at least two resistors connected in parallel.

15. The liquid crystal display device as claimed in claim 9, wherein each of the resistor units includes a plurality of resistors connected in series-parallel.

16. The liquid crystal display device as claimed in claim 9, further comprising a power source for providing voltage to the constant current source.
